(19) United States
(12) Patent Application Publication
(10) Pub. No.: US 2026/0361004 A1
(43) Pub. Date: Nov. 12, 2026

(54) CONNECTOR FOR FLAT WIRING MEMBER AND METHOD FOR CONNECTING SAME

(71) Applicant: YAZAKI CORPORATION, Tokyo (JP)

(72) Inventors: Naomi Kisu, Susono-shi (JP); Kenichi Katsumata, Susono-shi (JP); Masato Ando, Makinohara-shi (JP); Mitsuhisa Sano, Susono-shi (JP)

(21) Appl. No.: 19/646,056

(22) Filed: Apr. 13, 2026

(30) Foreign Application Priority Data
May 7, 2025 (JP) 2025-077476

(51) Int. Cl. H01R 4/26; H01R 4/18; H01R 4/70

(52) U.S. Cl. CPC H01R 4/26; H01R 4/182; H01R 4/70

(57) ABSTRACT

A connector for flat wiring member includes a flat wiring member in which an outer periphery of a strip-shaped flat conductor is covered with an insulating sheath; a terminal including a wiring member connection portion and a terminal connection portion connected to a mating terminal, the wiring member connection portion being provided with a first clamping flat plate portion and a second clamping flat plate portion for clamping an end in a longitudinal direction of the flat wiring member in a plate thickness direction; a piercing blade formed on the first clamping flat plate portion; a through hole formed in the second clamping flat plate portion; a connector housing provided with a pair of openings; and a connector cover for covering the pair of openings. A tip end of the piercing blade that penetrates through the through hole is crimped to an opening edge of the through hole.

### CROSS-REFERENCE TO RELATED APPLICATIONS

This application is based on and claims priority under 35 USC 119 from Japanese Patent Application No. 2025-077476 filed on May 7, 2025, the contents of which are incorporated herein by reference.

### TECHNICAL FIELD

The present disclosure relates to a connector for flat wiring member and a method for connecting the same.

### BACKGROUND ART

In the related art, as a connection method for electrically connecting a terminal and a flexible flat wiring member, such as a flexible flat cable (FFC), a piercing connection has been used in which a piercing blade of a terminal penetrates through a circuit body (conductor) of a flat wiring member without stripping a sheath of the flat wiring member (see Patent Literature 1).

In the piercing connection, the piercing blade formed on a wiring member connection portion of the terminal is aligned with and pierces through the conductor formed inside the wiring member (flat wiring member), and after penetration, a tip end is bent and crimped to connect the terminal and the wiring member. Then, a base end and the tip end of the piercing blade come into contact with the conductor of the wiring member, and the terminal and the wiring member are electrically connected.

### CITATION LIST

### Patent Literature

Patent Literature 1: JP2002-305050A

### SUMMARY OF INVENTION

However, the piercing connection as described above is generally used for a signal circuit body including a plurality of narrow flat conductors, and therefore, a small terminal width and a high retention force are not required. Therefore, the piercing connection is not suitable in a case of connecting to a wide flat conductor which is a circuit body with a relatively high current value such as a power supply circuit.

The present disclosure has been made in view of the above circumstances, and an object thereof is to provide a connector for flat wiring member and a method for connecting the same, which can perform a stable connection without stripping a sheath and can be applied to a flat wiring member having a wide flat conductor with a relatively high current value.

The above object of the present disclosure is achieved by the following configuration. A connector for flat wiring member includes a flat wiring member in which an outer periphery of a strip-shaped flat conductor is covered with an insulating sheath; a terminal including a wiring member connection portion and a terminal connection portion connected to a mating terminal, the wiring member connection portion being provided with a first clamping flat plate portion and a second clamping flat plate portion for clamping an end in a longitudinal direction of the flat wiring member in a plate thickness direction; a piercing blade configured to penetrate through the end in the longitudinal direction of the flat wiring member in the plate thickness direction and formed on the first clamping flat plate portion; a through hole formed in the second clamping flat plate portion to allow the piercing blade to penetrate through; a connector housing provided with a pair of openings for allowing an upper surface and a lower surface along a clamping direction of the wiring member connection portion of the terminal accommodated in a terminal accommodating chamber to expose to an outside of the housing; and a connector cover configured to cover the pair of openings. A tip end of the piercing blade that penetrates through the through hole is crimped to an opening edge of the through hole.

Further, the above object of the present disclosure is achieved by the following configuration. A method for connecting a connector for flat wiring member, the method includes accommodating, in a terminal accommodating chamber of a connector housing, a terminal including a wiring member connection portion and a terminal connection portion connected to a mating terminal, the wiring member connection portion being provided with a first clamping flat plate portion and a second clamping flat plate portion in a predetermined interval for clamping, in a plate thickness direction, an end in a longitudinal direction of a flat wiring member in which a striped-shaped flat conductor is covered with an insulating sheath; inserting the end in the longitudinal direction of the flat wiring member into the terminal accommodating chamber such that the end in the longitudinal direction of the flat wiring member is located between the first clamping flat plate portion provided with a piercing blade and the second clamping flat plate portion provided with a through hole through which the piercing blade penetrates; penetrating, through the through hole, the piercing blade piercing the end in the longitudinal direction of the flat wiring member in the plate thickness direction, and then crimping a tip end of the piercing blade to an opening edge of the through hole by a clamping pressure applied to the first clamping flat plate portion and the second clamping flat plate portion through a pair of openings formed in an upper wall and a bottom wall of the connector housing; and attaching a connector cover to the connector housing to cover the pair of openings.

The connector for flat wiring member and the method for connecting the same according to the present disclosure can perform a stable connection without stripping a sheath and can be applied to a flat wiring member having a wide flat conductor with a relatively high current value.

The present disclosure has been briefly described above. Further, the details of the present disclosure can be clarified by reading modes for carrying out the invention (hereinafter, referred to as "embodiments") to be described below with reference to the accompanying drawings.

### BRIEF DESCRIPTION OF DRAWINGS

FIG. 1 is an exploded perspective view illustrating an overall configuration of a connector for flat wiring member according to an embodiment of the present disclosure;

FIG. 2 is a perspective view illustrating a state in which a terminal is pre-assembled in a terminal accommodating chamber of a connector housing illustrated in FIG. 1;

FIG. 3 is a schematic cross-sectional view illustrating a state immediately before an end in a longitudinal direction of a flat wiring member is crimped to a wiring member connection portion of the terminal accommodated in the terminal accommodating chamber of the connector housing;

FIG. 4 is a schematic cross-sectional view illustrating a state after the end in the longitudinal direction of the flat wiring member is crimped to the wiring member connection portion of the terminal accommodated in the terminal accommodating chamber of the connector housing;

FIG. 5 is a perspective view of the connector for flat wiring member according to the present embodiment;

FIG. 6 is a longitudinal cross-sectional view of the connector for flat wiring member illustrated in FIG. 5;

FIG. 7 is an enlarged view of a portion VII in FIG. 6; and

FIG. 8 is a sectional view taken along a line VIII-VIII of FIG. 7.

### DESCRIPTION OF EMBODIMENTS

Hereinafter, specific embodiments according to the present disclosure will be described below with reference to the drawings.

A connector for flat wiring member 1 according to the present embodiment can be suitably used, for example, in a case of using, as an electrical wiring in electrical equipment, automobiles, and the like, a flat wiring member 10 in which an outer periphery of a wide flat conductor 11, which is a circuit body with a relatively high current value such as a power supply circuit, is covered with an insulating sheath 13.

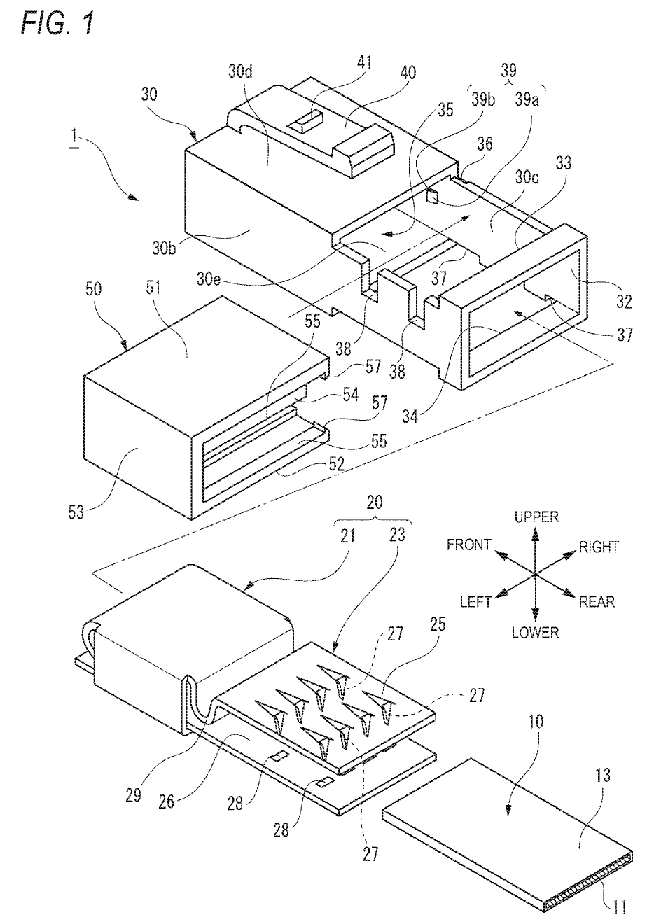

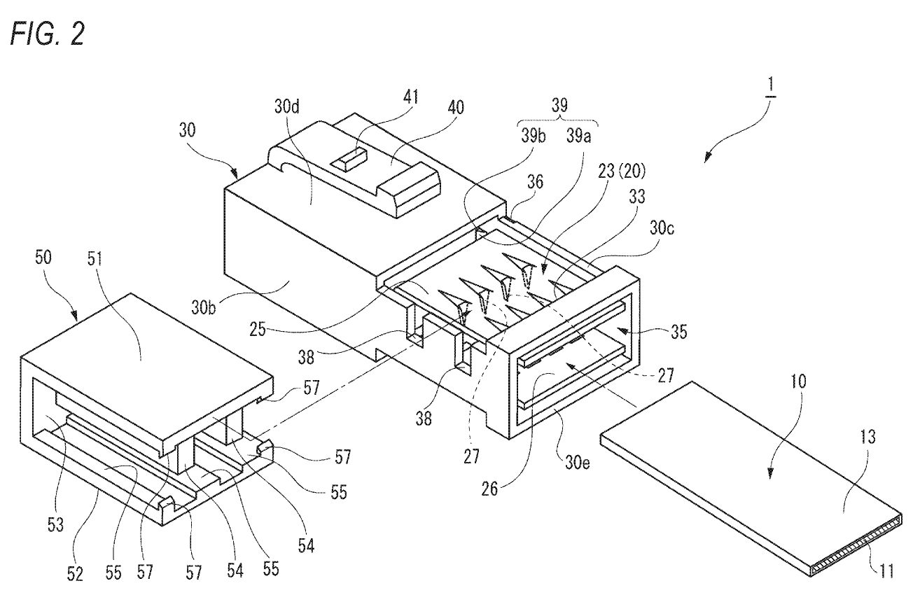

FIG. 1 is an exploded perspective view illustrating an overall configuration of the connector for flat wiring member 1 according to the embodiment of the present disclosure, and FIG. 2 is a perspective view illustrating a state in which a terminal 20 is pre-assembled in a terminal accommodating chamber 35 of a connector housing 30 illustrated in FIG. 1.

In the present embodiment, upper-lower, front-rear, and left-right directions in the connector for flat wiring member 1 follow upper-lower, front-rear, and left-right directions indicated by arrows in FIG. 1. That is, the front-rear direction is a direction along a connector fitting direction of the connector for flat wiring member 1, a side to be fitted into a fitted portion on a mating side is defined as a front side of the connector housing 30, and a leading-out direction of the flat wiring member 10 is defined as a rear side. The upper-lower direction is a plate thickness direction, which is perpendicular to the connector fitting direction of the connector for flat wiring member 1, of the flat wiring member 10. Further, the left-right direction is a connector width direction, which is perpendicular to the connector fitting direction and along a longitudinal direction of a substantially rectangular cross-section of the connector housing 30.

The connector for flat wiring member 1 according to the present embodiment, as illustrated in FIGS. 1 and 2, mainly includes the flat wiring member 10, the terminal 20, the connector housing 30, and a connector cover 50.

The flat wiring member 10 has electrical insulation properties and flexibility because an outer periphery of the strip-shaped flat conductor 11 is covered with the insulating sheath 13 and integrally formed. The flat conductor 11, which is applied to a power supply circuit that is wider than a signal circuit body, is made of, for example, copper or a copper alloy and aluminum or an aluminum alloy. The insulating sheath 13 is made of polypropylene (PP), polybutylene terephthalate (PBT), and the like.

The terminal 20 includes a wiring member connection portion 23 provided with a first clamping flat plate portion 25 and a second clamping flat plate portion 26 for clamping an end in a longitudinal direction of the flat wiring member 10 in the plate thickness direction, and a terminal connection portion 21 connected to a mating terminal (not illustrated). The terminal 20 is a female terminal integrally formed by punching a conductive metal plate made of copper or a copper alloy or the like into a predetermined shape and then bending the obtained product.

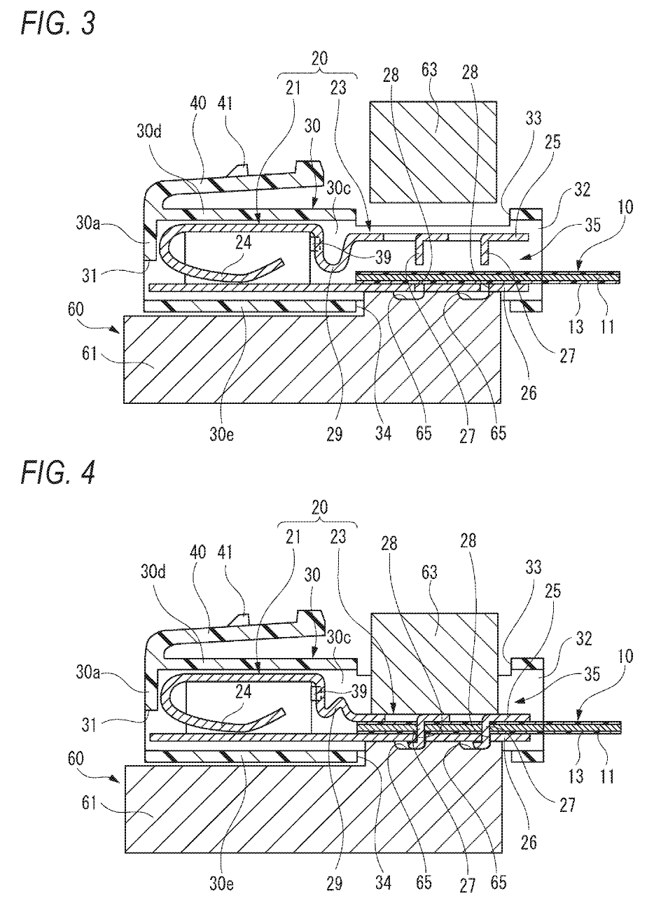

The terminal connection portion 21 is formed in a flat rectangular tubular shape, and has a spring piece 24 that elastically comes into contact with and is electrically connected to a male terminal, which is the mating terminal inserted between an upper wall and a bottom wall (see FIG. 3). The spring piece 24 is bent toward an inner side of the terminal from a front end of a top wall of the terminal connection portion 21 and extends in an insertion direction of the male terminal.

The first clamping flat plate portion 25 of the wiring member connection portion 23 is formed in a rectangular plate shape extending to a rear side from a rear end of the top wall of the terminal connection portion 21 via a connection portion 29 formed in a U shape from a cross-sectional view.

The first clamping flat plate portion 25 is provided with a plurality of piercing blades 27 that are cut and raised to a lower side of the terminal to penetrate through the end in the longitudinal direction of the flat wiring member 10 in the plate thickness direction. In the present embodiment, eight of the triangular piercing blades 27 are arranged in such a manner that four triangular piercing blades 27 are arranged in a left-right width direction of the first clamping flat plate portion 25 and two rows thereof are arranged along the front-rear direction.

The second clamping flat plate portion 26 of the wiring member connection portion 23 is formed in a rectangular plate shape extending toward a rear side from a rear end of a bottom wall of the terminal connection portion 21.

The second clamping flat plate portion 26 is provided with a plurality of through holes 28 to allow the plurality of piercing blades 27 to penetrate therethrough. Eight rectangular through holes 28 are arranged in such a manner that four through holes 28 are arranged in the left-right width direction of the second clamping flat plate portion 26 and two rows thereof are arranged along the front-rear direction to face the plurality of piercing blades 27 respectively.

The first clamping flat plate portion 25 and the second clamping flat plate portion 26 are formed to be parallel to each other with a predetermined interval. This predetermined interval is set such that an interval between tip ends of the piercing blades 27 on the first clamping flat plate portion 25 and an inner surface of the second clamping flat plate portion 26 is greater than a plate thickness of the flat wiring member 10 (see FIG. 3).

The connector housing 30 is integrally molded from an insulating resin into a substantially rectangular tubular shape, and the terminal 20 is inserted into the terminal accommodating chamber 35 from a rear opening 32. An insertion opening 31 into which the mating terminal is inserted is formed in a front wall 30a of the connector housing 30 (see FIG. 3).

Furthermore, in order to expose an upper surface and a lower surface along a clamping direction of the wiring member connection portion 23 of the terminal 20 inserted into the terminal accommodating chamber 35 to an outside of the housing, a pair of openings 33 and 34 are formed in an upper wall 30d and a bottom wall 30e at a rear side of the connector housing 30.

An elastically deformable cantilevered flexible arm 40 is formed on an outer surface of the upper wall 30d at a front side of the connector housing 30. The flexible arm 40 includes a latching projection 41, and the connector housing 30 is prevented from coming loose from the fitted portion by the latching projection 41 latched to a latching portion (not illustrated) formed on the fitted portion on the mating side.

A pair of notches 38 corresponding to a pair of restricting protrusions 54 of the connector cover 50 to be described later are formed on an upper edge of a left side wall 30b adjacent to the opening 33 of the connector housing 30.

Four engaging recesses 36 corresponding to four engaging projections 57 of the connector cover 50 to be described later are formed in an outer surface of an upper edge and a lower edge of a right side wall 30c adjacent to the openings 33 and 34 of the connector housing 30.

Three notches 37 corresponding to three restricting protrusions 55 of the connector cover 50 to be described later are formed on the lower edge of the right side wall 30c adjacent to the opening 34.

Further, locking protrusions 39 for constituting a locking mechanism that retains the terminal 20 in the terminal accommodating chamber 35 protrude from inner surfaces of the left and right side walls 30b and 30c. Each of the locking protrusions 39 has a tapered surface for insertion 39a at a rear side and a vertical surface for latching 39b at a front side.

as illustrated in FIGS. 1 and 2, the connector cover 50 includes a top plate portion 51 and a bottom plate portion 52 facing each other, and a connection plate portion 53 connecting one side of each of the top plate portion 51 and the bottom plate portion 52, and is integrally molded from a synthetic resin into a U shape from the cross-sectional view. The connector cover 50 is attached to the connector housing 30 from the connector width direction, which intersects the insertion direction of the terminal 20, so that the top plate portion 51 and the bottom plate portion 52 sandwich the connector housing 30 from above and below, thereby covering the pair of openings 33 and 34 formed in the upper and bottom walls 30d and 30e of the connector housing 30, respectively.

The connector cover 50 includes the pair of restricting protrusions 54 protruding from an inner wall surface of the top plate portion 51, and the three restricting protrusions 55 protruding from an inner wall surface of the bottom plate portion 52. These restricting protrusions 54 and 55 are ridges extending in the connector width direction, and restrict movement of the wiring member connection portion 23 of the terminal 20 accommodated in the connector housing 30 in the clamping direction (see FIG. 6).

Two pairs of engaging projections 57 projecting toward the inner side and facing each other are provided at free ends (right ends in FIG. 1) of the top plate portion 51 and the bottom plate portion 52. These four engaging projections 57 engage with the four engaging recesses 36 formed in the upper edge and the lower edge of the right side wall 30c of the connector housing 30, so that the connector cover 50 is latched to the connector housing 30.

Next, a method for connecting the connector for flat wiring member 1 described above will be described.

FIG. 3 is a schematic cross-sectional view illustrating a state immediately before the end in the longitudinal direction of the flat wiring member 10 is crimped to the wiring member connection portion 23 of the terminal 20 accommodated in the terminal accommodating chamber 35 of the connector housing 30. FIG. 4 is a schematic cross-sectional view illustrating a state after the end in the longitudinal direction of the flat wiring member 10 is crimped to the wiring member connection portion 23 of the terminal 20 accommodated in the terminal accommodating chamber 35 of the connector housing 30.

### Step of Accommodating Terminal 20 in Terminal Accommodating Chamber 35 of Connector Housing 30

First, the terminal 20, which includes the wiring member connection portion 23 provided with the first clamping flat plate portion 25 and the second clamping flat plate portion 26 in a predetermined interval and the terminal connection portion 21 connected to the mating terminal, is accommodated in the terminal accommodating chamber 35 of the connector housing 30.

Specifically, the terminal 20 is inserted into the terminal accommodating chamber 35 from the rear opening 32 of the connector housing 30 and is moved toward the front side. When the terminal 20 is moved toward the front side of the terminal accommodating chamber 35, both side walls of the terminal connection portion 21 are moved toward the front side by climbing over the tapered surfaces for insertion 39a of the locking protrusions 39.

Further, when a tip end of the terminal 20 is inserted until the tip end abuts against the front wall 30a of the connector housing 30, rear edges of both side walls of the terminal connection portion 21 are latched to the vertical surfaces for latching 39b of the locking protrusion 39 (see FIG. 3). That is, the front wall 30a and the locking protrusion 39 of the connector housing 30 constitute the locking mechanism that retains the terminal 20 in the terminal accommodating chamber 35. Therefore, as illustrated in FIG. 2, the terminal 20 is in a pre-assembled state, that is, is retained in the terminal accommodating chamber 35 of the connector housing 30.

### Step of Inserting End in Longitudinal Direction of Flat Wiring Member 10 into Terminal Accommodating Chamber 35

Next, the end in the longitudinal direction of the flat wiring member 10 is inserted into the terminal accommodating chamber 35 of the connector housing 30.

Specifically, the end in the longitudinal direction of the flat wiring member 10 is inserted into the terminal accommodating chamber 35 from the rear opening 32 of the connector housing 30 such that the end is located between the first clamping flat plate portion 25 and the second clamping flat plate portion 26 of the terminal 20 accommodated in the terminal accommodating chamber 35. In this case, the end in the longitudinal direction of the flat wiring member 10 inserted into the terminal accommodating chamber 35 is inserted along the second clamping flat plate portion 26 so as not to come into contact with the piercing blades 27.

### Step of Crimping End in Longitudinal Direction of Flat Wiring Member 10 to Wiring Member Connection Portion 23 of Terminal 20

Next, the end in the longitudinal direction of the flat wiring member 10 is crimped to the wiring member connection portion 23 of the terminal 20 by a crimping die 60.

Specifically, first, as illustrated in FIG. 3, the end in the longitudinal direction of the flat wiring member 10 accommodated in the terminal accommodating chamber 35 of the connector housing 30 is placed on a lower die 61 of the crimping die 60. Here, recesses 65 that bend the tip ends of the piercing blades 27 along an inner surface are formed in the lower die 61 which penetrates through the opening 34 formed in the bottom wall 30e of the connector housing 30 and faces the second clamping flat plate portion 26.

Next, as illustrated in FIG. 4, an upper die 63 of the crimping die 60, which faces the first clamping flat plate portion 25, is moved toward a lower side through the opening 33 formed in the upper wall 30d of the connector housing 30, and a clamping pressure is applied to the first clamping flat plate portion 25 and the second clamping flat plate portion 26 between the lower die 61 and the upper die 63.

Then, the first clamping flat plate portion 25 moves toward the lower side in parallel while deforming the connection portion 29, so that the plurality of piercing blades 27 pierce the end in the longitudinal direction of the flat wiring member 10 in the plate thickness direction, and further penetrate through the plurality of through holes 28 of the second clamping flat plate portion 26 respectively. The tip ends of the piercing blades 27 that penetrate through the through holes 28 are bent along the inner surfaces of the recesses 65, thereby being crimped to opening edges of the through holes 28.

Therefore, the piercing blades 27 of the first clamping flat plate portion 25 that penetrates through the end in the longitudinal direction of the flat wiring member 10 are in electrical contact with the flat conductor 11. The tip ends of the piercing blades 27 that penetrate through the flat wiring member 10 are crimped to the opening edges of the through holes 28 of the second clamping flat plate portion 26, and the wiring member connection portion 23 of the terminal 20 and the flat wiring member 10 are crimp-joined. That is, by making the first clamping flat plate portion 25 and the second clamping flat plate portion 26, which clamp the end in the longitudinal direction of the flat wiring member 10 in the plate thickness direction, into a crimping structure, a strong and stable connection between the flat wiring member 10 and the terminal 20 can be obtained.

By increasing the number of conductor penetration and crimping portions between the piercing blades 27 of the first clamping flat plate portion 25 and the through holes 28 of the second clamping flat plate portion 26, a contact area between the wiring member connection portion 23 of the terminal 20 and the flat conductor 11 of the flat wiring member 10 increases, and current can be stably applied.

### Step of Attaching Connector Cover 50 to Connector Housing 30

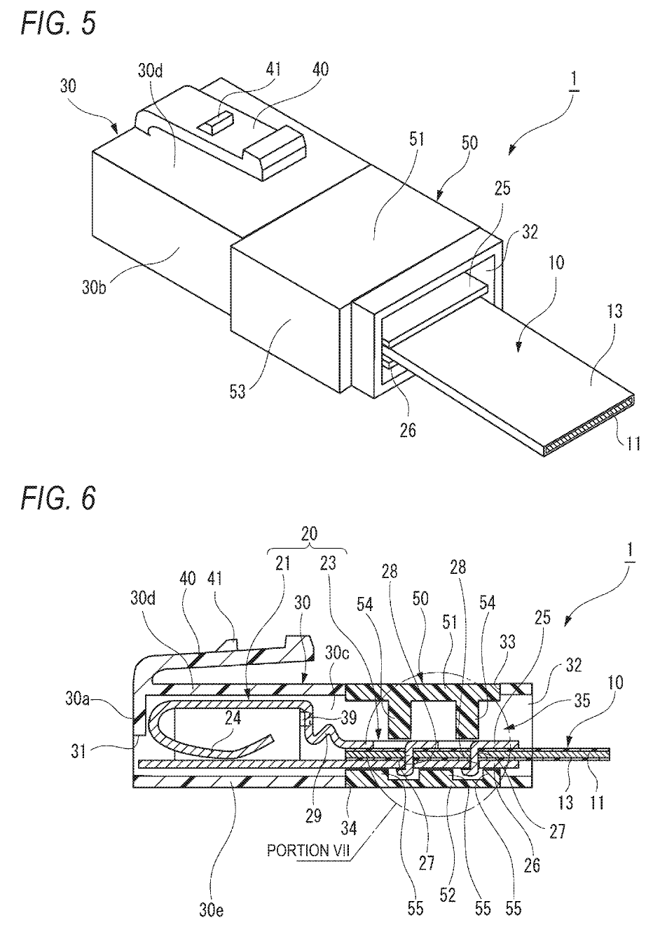

Next, as illustrated in FIGS. 5 and 6, the connector cover 50 is attached to the connector housing 30.

Specifically, the top plate portion 51 and the bottom plate portion 52 of the connector cover 50 are attached while being slid from a left side of the connector housing 30 to sandwich the connector housing 30 from above and below. In this case, since the pair of notches 38 are formed in the upper edge of the left side wall 30b of the connector housing 30, the pair of restricting protrusions 54 of the connector cover 50 do not bring interference to hinder the attachment.

When the top plate portion 51 and the bottom plate portion 52 slide to a position where the pair of openings 33 and 34 are covered, the engaging projections 57 protruding from the free ends of the top plate portion 51 and the bottom plate portion 52 are engaged with the engaging recesses 36 of the connector housing 30 respectively, and the connector cover 50 is latched to the connector housing 30. In this case, since the three notches 37 are formed in the lower edge of the right side wall 30c of the connector housing 30, the three restricting protrusions 55 of the connector cover 50 do not bring interference to hinder the engagement.

Therefore, the upper surface and the lower surface of the wiring member connection portion 23 of the terminal 20, which are exposed to the outside of the housing from the openings 33 and 34 of the connector housing 30, are covered with and protected by the top plate portion 51 and the bottom plate portion 52 of the connector cover 50.

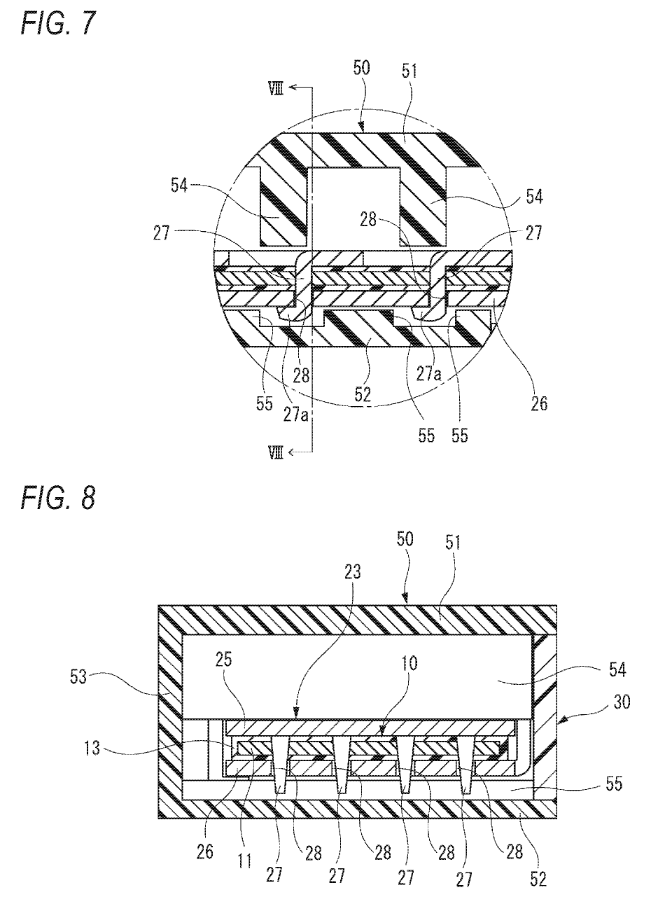

As illustrated in FIGS. 6-8, the connector cover 50 attached to the connector housing 30 can retain a state in which movement of the wiring member connection portion 23 of the terminal 20 accommodated in the terminal accommodating chamber 35 in the clamping direction is restricted (rattling is prevented) by the pair of restricting protrusions 54 protruding from the inner wall surface of the top plate portion 51 and the three restricting protrusions 55 protruding from the inner wall surface of the bottom plate portion 52.

As described above, in the connector for flat wiring member 1 according to the present embodiment, the plurality of piercing blades 27 of the first clamping flat plate portion 25 in the wiring member connection portion 23 of the terminal 20 pierce the end in the longitudinal direction of the flat wiring member 10 in the plate thickness direction, and the tip ends of the piercing blades 27 that penetrate through the plurality of through holes 28 of the second clamping flat plate portion 26 are crimped to the opening edges of the through holes 28.

Therefore, according to the connector for flat wiring member 1 and a method for connecting the same according to the present embodiment, by making the first clamping flat plate portion 25 and the second clamping flat plate portion 26, which clamp the end in the longitudinal direction of the flat wiring member 10 in the plate thickness direction, into a crimping structure, a strong and stable connection between the flat conductor 11 and the terminal 20 can be obtained without stripping the insulating sheath 13 of the flat wiring member 10. By increasing the number of conductor penetration and crimping portions between the piercing blades 27 of the first clamping flat plate portion 25 and the through holes 28 of the second clamping flat plate portion 26, the contact area between the wiring member connection portion 23 of the terminal 20 and the flat conductor 11 of the flat wiring member 10 increases, and current can be stably applied.

As a result, the connector for flat wiring member 1 and the method for connecting the same according to the present embodiment can be applied to the flat wiring member 10 including the wide flat conductor 11, which is a circuit body with a relatively high current value, such as a power supply circuit.

The connector housing 30 of the connector for flat wiring member 1 according to the present embodiment includes the front wall 30a and the locking protrusions 39 as the locking mechanism for latching the terminal 20 in the terminal accommodating chamber 35.

Therefore, in the connector for flat wiring member 1, the wiring member connection portion 23 and the end in the longitudinal direction of the flat wiring member 10 can be crimp-joined while the terminal 20 is pre-assembled in the terminal accommodating chamber 35 of the connector housing 30. Therefore, a post-fitting process of fitting a terminal connected to an end of a flat wiring member in the related art into a connector housing is eliminated, thereby improving a connector assembling efficiency.

In the connector cover 50 of the connector for flat wiring member 1 according to the present embodiment, the restricting protrusions 54 and 55, which restrict the movement of the wiring member connection portion 23 of the terminal 20 in the clamping direction, protrude from the inner wall surface of the top plate portion 51 and the inner wall surface of the bottom plate portion 52 which cover the pair of openings 33 and 34 of the connector housing 30.

Therefore, the connector cover 50 attached to the connector housing 30 can retain a state in which rattling in the clamping direction of the wiring member connection portion 23 of the terminal 20 accommodated in the terminal accommodating chamber 35 of the connector housing 30 is prevented.

The present disclosure is not limited to the above embodiments, and can be appropriately modified, improved, or the like. In addition, materials, shapes, sizes, numbers, arrangement positions, and the like of components in the above embodiments are freely selected and are not limited as long as the present disclosure can be implemented.

For example, the configurations of the piercing blades and the through holes of the present disclosure are not limited to the configurations of the piercing blades 27 and the through holes 28 in the above embodiments, and it goes without saying that the number, the shape, and the arrangement of these piercing blades and through holes can take various forms.

The configuration of the terminal connection portion of the terminal and the configuration of the locking mechanism that retains the terminal in the terminal accommodating chamber are not limited to the configurations of the above embodiments, and it goes without saying that various configurations can be adopted based on the gist of the present disclosure.

Here, features of the embodiments of the connector for flat wiring member and the method for connecting the same according to the present disclosure described above are briefly summarized and listed in the following [1] to [4], respectively.

[1] A connector for flat wiring member (1) including:
a flat wiring member (10) in which an outer periphery of a strip-shaped flat conductor (11) is covered with an insulating sheath (13);
a terminal (20) including a wiring member connection portion (23) provided with a first clamping flat plate portion (25) and a second clamping flat plate portion (26) for clamping an end in a longitudinal direction of the flat wiring member (10) in a plate thickness direction, and a terminal connection portion (21) connected to a mating terminal;
a piercing blade (27) configured to penetrate through the end in the longitudinal direction of the flat wiring member (10) in the plate thickness direction and formed on the first clamping flat plate portion (25);
a through hole (28) formed in the second clamping flat plate portion (26) to allow the piercing blade (27) to penetrate through;
a connector housing (30) provided with a pair of openings (33, 34) for allowing an upper surface and a lower surface along a clamping direction of the wiring member connection portion (23) of the terminal (20) accommodated in a terminal accommodating chamber (35) to expose to an outside of the housing; and
a connector cover (50) configured to cover the pair of openings (33, 34), in which
a tip end (27a) of the piercing blade (27) that penetrates through the through hole (28) is crimped to an opening edge of the through hole (28).

According to the connector for flat wiring member (1) having the configuration in the above [1], by making the first clamping flat plate portion (25) and the second clamping flat plate portion (26), which clamp the end in the longitudinal direction of the flat wiring member (10) in the plate thickness direction, into a crimping structure, a strong and stable connection between the flat conductor (11) and the terminal (20) can be obtained without stripping the insulating sheath (13) of the flat wiring member (10). By increasing the number of conductor penetration and crimping portions between the piercing blade (27) of the first clamping flat plate portion (25) and the through hole (28) of the second clamping flat plate portion (26), a contact area between the wiring member connection portion (23) of the terminal (20) and the flat conductor (11) of the flat wiring member (10) increases, and current can be stably applied.

[2] The connector for flat wiring member (1) according to the above [1], in which
the connector housing (30) includes a locking mechanism (front wall 30a and locking protrusion 39) that retains the terminal (20) in the terminal accommodating chamber (35).

According to the connector for flat wiring member (1) having the configuration in the above [2], the wiring member connection portion (23) and the end in the longitudinal direction of the flat wiring member (10) can be crimp-joined while the terminal (20) is pre-assembled in the terminal accommodating chamber (35) of the connector housing (30). Therefore, a post-fitting process of fitting a terminal connected to an end of a flat wiring member in the related art into a connector housing is eliminated, thereby improving a connector assembling efficiency.

[3] The connector for flat wiring member (1) according to the above [1] or [2], in which
the connector cover (50) is formed in a U shape from a cross-sectional view, and includes a top plate portion (51) and a bottom plate portion (52) that cover the pair of openings (33, 34), and a connection plate portion (53) that connects one side of each of the top plate portion (51) and the bottom plate portion (52), and
restricting protrusions (54, 55) that restrict movement of the wiring member connection portion (23) in the clamping direction protrude from an inner wall surface of the top plate portion (51) and an inner wall surface of the bottom plate portion (52).

According to the connector for flat wiring member (1) having the configuration in the above [3], the connector cover (50) attached to the connector housing (30) can retain a state in which the movement in the clamping direction of the wiring member connection portion (23) of the terminal (20) accommodated in the terminal accommodating chamber (35) of the connector housing (30) is restricted (rattling is prevented).

[4] A method for connecting a connector for flat wiring member, the method including:
a step of accommodating, in a terminal accommodating chamber (35) of a connector housing (30), a terminal (20) including a wiring member connection portion (23) and a terminal connection portion (21) connected to a mating terminal, the wiring member connection portion (23) being provided with a first clamping flat plate portion (25) and a second clamping flat plate portion (26) in a predetermined interval for clamping, in a plate thickness direction, an end in a longitudinal direction of a flat wiring member (10) in which a striped-shaped flat conductor (11) is covered with an insulating sheath (13);
a step of inserting the end in the longitudinal direction of the flat wiring member (10) into the terminal accommodating chamber (35) such that the end in the longitudinal direction of the flat wiring member (10) is located between the first clamping flat plate portion (25) provided with a piercing blade (27) and the second clamping flat plate portion (26) provided with a through hole (28) through which the piercing blade (27) penetrates;
a step of penetrating, through the through hole (28), the piercing blade (27) piercing the end in the longitudinal direction of the flat wiring member (10) in the plate thickness direction, and then crimping a tip end (27a) of the piercing blade (27) to an opening edge of the through hole (28) by a clamping pressure applied to the first clamping flat plate portion (25) and the second clamping flat plate portion (26) through a pair of openings (33, 34) formed in an upper wall and a bottom wall (30d, 30e) of the connector housing (30); and
a step of attaching a connector cover (50) to the connector housing (30) to cover the pair of openings (33, 34).

According to the method for connecting a connector for flat wiring member having the configuration in the above [4], by making the first clamping flat plate portion (25) and the second clamping flat plate portion (26), which clamp the end in the longitudinal direction of the flat wiring member (10) in the plate thickness direction, into a crimping structure, a strong and stable connection between the flat conductor (11) and the terminal (20) can be obtained without stripping the insulating sheath (13) of the flat wiring member (10).

What is claimed is:

1. A connector for flat wiring member comprising:
a flat wiring member in which an outer periphery of a strip-shaped flat conductor is covered with an insulating sheath;
a terminal including a wiring member connection portion and a terminal connection portion connected to a mating terminal, the wiring member connection portion being provided with a first clamping flat plate portion and a second clamping flat plate portion for clamping an end in a longitudinal direction of the flat wiring member in a plate thickness direction;
a piercing blade configured to penetrate through the end in the longitudinal direction of the flat wiring member in the plate thickness direction and formed on the first clamping flat plate portion;
a through hole formed in the second clamping flat plate portion to allow the piercing blade to penetrate through;
a connector housing provided with a pair of openings for allowing an upper surface and a lower surface along a clamping direction of the wiring member connection portion of the terminal accommodated in a terminal accommodating chamber to expose to an outside of the housing; and
a connector cover configured to cover the pair of openings, wherein
a tip end of the piercing blade that penetrates through the through hole is crimped to an opening edge of the through hole.

2. The connector for flat wiring member according to claim 1, wherein
the connector housing includes a locking mechanism that retains the terminal in the terminal accommodating chamber.

3. The connector for flat wiring member according to claim 1, wherein
the connector cover is formed in a U shape from a cross-sectional view, and includes a top plate portion and a bottom plate portion that cover the pair of openings, and a connection plate portion that connects one side of each of the top plate portion and the bottom plate portion, and
restricting protrusions that restrict movement of the wiring member connection portion in the clamping direction protrude from an inner wall surface of the top plate portion and an inner wall surface of the bottom plate portion.

4. A method for connecting a connector for flat wiring member, the method comprising:
accommodating, in a terminal accommodating chamber of a connector housing, a terminal including a wiring member connection portion and a terminal connection portion connected to a mating terminal, the wiring member connection portion being provided with a first clamping flat plate portion and a second clamping flat plate portion in a predetermined interval for clamping, in a plate thickness direction, an end in a longitudinal direction of a flat wiring member in which a striped-shaped flat conductor is covered with an insulating sheath;
inserting the end in the longitudinal direction of the flat wiring member into the terminal accommodating chamber such that the end in the longitudinal direction of the flat wiring member is located between the first clamping flat plate portion provided with a piercing blade and the second clamping flat plate portion provided with a through hole through which the piercing blade penetrates;
penetrating, through the through hole, the piercing blade piercing the end in the longitudinal direction of the flat wiring member in the plate thickness direction, and then crimping a tip end of the piercing blade to an opening edge of the through hole by a clamping pressure applied to the first clamping flat plate portion and the second clamping flat plate portion through a pair of openings formed in an upper wall and a bottom wall of the connector housing; and
attaching a connector cover to the connector housing to cover the pair of openings.
